(19) United States
(12) Patent Application Publication
(10) Pub. No.: US 2009/0266840 A1
(43) Pub. Date: Oct. 29, 2009

(54) Substance Injecting Apparatuses and Methods for Using Same

(75) Inventors: Dvir Brand, Kfar-Saba (IL); Brian H. Bunnett, Highland Village, TX (US); Philip Neil Theurer, Glen Allen, VA (US); Shlomo Nevo, Tel-Aviv (IL); Uzi Emanuel Aharony, Even-Yehuda (IL); Jonathan Knaan, Kiryat-Ata (IL)

Correspondence Address: MCDERMOTT, WILL & EMERY LLP;Attn: IP Department, 227 WEST MONROE STREET, SUITE 4400, CHICAGO, IL, 60606-5096, US

(73) Assignee: Foam in Place Co., Ltd.

(21) Appl. No.: 12/084,984

(22) PCT Filed: Nov. 15, 2006
(86) PCT No.: PCT/IB06/54272

§ 371 Date: Jun. 30, 2009

Related U.S. Application Data
(60) Provisional application No. 60/736,801, filed on Nov. 15, 2005.
(60) Provisional application No. 60/754,101, filed on Dec. 27, 2005.

(51) Int. Cl. B67D 5/00; B67D 5/06; F16K 11/00

(52) U.S. Cl. 222/1; 222/145.5; 137/625.2; 222/333; 222/23

(57) ABSTRACT

A chemical injection system, comprising: a drive mechanism; a housing removably attached to the drive mechanism; at least one chemical inlet located on the housing; and, a valve spool located within the housing and provided with at least one chemical pass-through port, wherein the drive mechanism rotates the valve spool to align the chemical pass-through port with the chemical inlet.

### RELATED APPLICATIONS

This application is related to U.S. Applications 60/736,801 filed on Nov. 15, 2005 and 60/754,101 filed on Dec. 27, 2005, the disclosures of which are incorporated by reference.

### FIELD OF THE INVENTION

The present invention relates to substance transportation, for example chemical injecting apparatuses and methods for reacting and injecting the chemicals.

### BACKGROUND OF THE INVENTION

In the packing material manufacturing industry, various component materials are often combined to create a final product packing material. Often this component material mixing occurs at the actual site where the packing material is to be used for packing. In order to conduct this mixing, component materials are pumped from reservoirs and then the various components are added to each other in a mixing chamber. Sometimes the mixing chamber is in a “gun” type apparatus which is primarily used to inject the components in a directed manner towards a target container. A disadvantage of reacting chemicals together to form a packing material is that it often leads to undesirable build-up of reacted chemicals within the chemical injection system and in and around the component parts which deliver the reacted chemicals to their final destination, such as a package or a bag. This chemical build-up can eventually degrade the performance of the chemical injection system to the point of rendering it unfit for its purpose. A number of solutions are used to combat this build-up problem including using solvent to cleanse of the reacted chemicals or mechanical cleansing (e.g. scraping off the build-up, as in the Petcen patent described below).

U.S. Pat. No. 5,964,378 to Sperry, et al., the disclosure of which is herein incorporated by reference, describes a mixing chamber assembly having a reciprocating rod within a mixing chamber of a mixing chamber member. The mixing chamber member is preferably received within a dispenser housing such that it is free to shift between dispensing and non-dispensing modes with a shuttle valve arranged between the housing and mixing chamber to seal off foam chemical precursors from entering the mixing chamber when in a non-dispensing mode. In the Sperry patent and its related progeny U.S. Pat. Nos. 5,996,848 and 6,311,740, the disclosures of which are herein incorporated by reference, the solvent flows through the mixing chamber chemical ports in the reverse direction from the chemical flow.

U.S. Pat. No. 5,211,311 to Petcen, the disclosure of which is herein incorporated by reference, describes a replaceable cartridge for use in a mixing, dispensing and purging apparatus of mutually reactive chemicals. The cartridge comprises a mixing assembly and purging rod. The mixing assembly also includes a scraper assembly positioned within the mixing assembly. In this type of mixing chamber the purge rod acts as both the cleaning member and the valving member. The mixing chamber is typically made of Teflon or similar material that cold flows under pressure. The mixing chamber is placed under pressure by the use of Bellville washers stacked against one end. This causes the material to squeeze around the purge/valve rod which is in interference fit. The rod then forms a seal against the wall of the mixing chamber. Pulling the rod back exposes the chemical inlets and starts the flow of chemicals. With time however the rod may get a build up of chemical reactants, no longer providing a good seal, hence the need for scraping the exterior surface of the rod in an attempt to keep it clean.

U.S. Pat. No. 5,027,975 to Keske, et al., the disclosure of which is herein incorporated by reference, describes a dispensing gun for mixing and dispensing reactable fluid materials which incorporates a slidable cylinder within a bore. As the cylinder moves in the bore, orifices in the wall of the cylinder become aligned with supply passages in the bore allowing the reactable fluid materials to mix in the cylinder and be dispensed from the discharge opening.

### SUMMARY OF THE INVENTION

An aspect of some exemplary embodiments of the invention relates to providing a chemical injection system with rotational alignment of at least one pass-through port on a valve spool defining a mixing chamber and at least one chemical inlet port. Optionally, at least one chemical injected by the chemical injection system is a component of a packing material. In some exemplary embodiments of the invention, chemical flow from the at least one chemical inlet port into the mixing chamber is actuated by a drive mechanism. Optionally, the mixing chamber is defined by a valve spool provided with at least one chemical pass-though port, which when the valve spool pass-through port is rotationally aligned with the chemical inlet port, chemical flows into the mixing chamber. In some exemplary embodiments of the invention, the drive mechanism is used to supply motive force to a purge rod located within the chemical injection system. Optionally, the chemical injection system uses a cartridge, capable of quick replacement and useable in a plurality of differently configured machines. In some exemplary embodiments of the invention, at least one sensor is provided to the chemical injection system to help determine the operational status of the purge rod. Optionally, the at least one sensor is a latching bipolar magnetic sensor.

An aspect of some exemplary embodiments of the invention relates to a method which provides over-travel movement to a purge rod of a chemical injection system for assisting with breaking any reacted chemical buildup. Optionally, the over-travel movement occurs at the beginning of an injection cycle of the chemical injection system. Optionally, the over-travel movement includes moving the purge rod towards an outlet of the chemical injection system prior to moving away from the outlet.

An aspect of some exemplary embodiments of the invention relates to providing a cartridge with a solvent cleansed, moving mixing chamber capable of being replaced quickly and easily. Optionally, at least one chemical is injected by the cartridge which is a component of a packing material. In some exemplary embodiments of the invention, the cartridge is used with a chemical injection system for filling containers with packing material injected from the chemical injection system.

In some exemplary embodiments of the invention, the cartridge is adapted and constructed to be interchangeably used in more than one type of substance injection machine. In some exemplary embodiments of the invention, one type of substance injection machine is handheld. In some exemplary embodiments of the invention, the substance injecting cartridge is mounted in a non-handheld substance injection machine.

In some exemplary embodiments of the invention, a drive mechanism is used to provide motive force to at least a purge rod and/or a valve spool of the cartridge. Optionally, the cartridge is adapted so that the drive mechanism provides linear motion to the valve spool. Optionally, the cartridge is adapted so that the drive mechanism provides rotational motion to the valve spool. In some exemplary embodiments of the invention, the cartridge is adapted to be compatible for use with a plurality of drive mechanisms.

An aspect of some exemplary embodiments of the invention relates to providing at least one chemical inlet port with bias towards a valve spool in order to form a better seal between the two. In an exemplary embodiment of the invention, at least one chemical inlet port is provided with at least one o-ring which urges the chemical inlet port towards the valve spool. Optionally, at least one o-ring is comprised of an elastic material, such as rubber. In some exemplary embodiments of the invention, at least one o-ring is placed around an exterior surface of the chemical inlet port. Optionally, upon installation the diameter of the at least one o-ring is greater than the space allowed for the at least one o-ring, thereby compressing the o-ring and causing it to urge the chemical inlet port towards the valve spool.

An aspect of some exemplary embodiments of the invention relates to providing a perforated solvent groove to a valve spool of a chemical injection system for creating uniform solvent distribution, reduced chemical buildup, and/or tip cleansing. In some exemplary embodiments of the invention, the solvent groove is provided with at least one hole for the transmission of solvent therethrough. Optionally, a plurality of holes are equally spaced around the circumference of the solvent groove to assist with uniform solvent dispersion. Optionally, the grooved nature of the solvent groove reduces the thickness of the valve spool thereby reducing the likelihood of reacted chemical buildup in the holes located therein. In some exemplary embodiments of the invention, the holes provided to solvent groove enable solvent to exit from the valve spool over a tip of the chemical injection system, thereby cleansing the tip.

An aspect of some exemplary embodiments of the invention relates to providing solvent cleansing to the outlet of a substance injecting cartridge at the beginning of an injection cycle. In some exemplary embodiments of the invention, cleansing the outlet of the substance injecting cartridge at the beginning of an injection cycle serves to reduce any build-up of substances at or near the outlet of the cartridge from previous injection cycles. In some exemplary embodiments of the invention, solvent is pumped over the cartridge outlet at the beginning of an injection cycle by a purging rod as it moves towards an “open” position, wherein the “open” position is a configuration for introducing substances into the substance injection cartridge. Optionally, solvent is pumped out of a circumferential groove located near the tip in order to cleanse the outlet.

An aspect of some exemplary embodiments of the invention relates to providing a handheld chemical injection system with more than one control mechanism for controlling the operation of the handheld chemical injection system for injecting chemicals. Optionally, a control mechanism is a trigger for activating at least a portion of the chemical injection system. Optionally, a control mechanism is a switch for selecting operational modes of the chemical injection system. For example, the switch is provided for switching between manual and automatic chemical injection. As another example, the switch is provided for selecting at least one of a plurality of predefined injection operation profiles. Optionally, the switch is used to select specific bolus sizes of chemicals being injected.

An aspect of some exemplary embodiments of the invention relates to providing a display to a handheld portion of a chemical injection system. In some exemplary embodiments of the invention, the display provides information regarding the chemical injection system to an operator of the system. Optionally, the information pertains to the status of the chemical injection system in relation to an injection cycle. Optionally, the information pertains to the amount of supply materials (e.g. solvent and/or chemicals) remaining in supply reservoirs.

There is thus provided in accordance with some aspects of the invention, a chemical injection system, comprising: a drive mechanism; a housing removably attached to the drive mechanism; at least one chemical inlet located on the housing; and, a valve spool located within the housing and provided with at least one chemical pass-through port, wherein the drive mechanism rotates the valve spool to align the chemical pass-through port with the chemical inlet. In some exemplary embodiments of the invention, the system further comprises a purge rod located within the valve spool and connected to the drive mechanism. Optionally, the purge rod and the valve spool are located within the housing and comprise a cartridge. Optionally, the drive mechanism provides over-travel movement to the purge rod. Optionally, the system is provided with at least one sensor for determining the operational status of the purge rod. Optionally, the at least one sensor is a bipolar magnetic sensor. Optionally, the drive mechanism is comprised of at least a worm and a worm gear. Optionally, the valve spool defines a mixing chamber located in a lumen of the valve spool. Optionally, the valve spool further comprises an outlet.

There is thus provided in accordance with some aspects of the invention, a cartridge for a chemical injection system, comprising: a housing provided with at least one chemical inlet port and at least one solvent inlet port for introducing solvent to the cartridge; a valve spool, located concentrically within the housing, defining a mixing chamber and provided with at least one chemical pass-through port; and, a purge rod, slidably located within the valve spool and provided with a connection for coupling the purge rod to a drive mechanism; wherein the at least one chemical inlet port of the housing aligns with the at least one chemical pass-through port of the mixing chamber during chemical injection. In some exemplary embodiments of the invention, the cartridge further comprises a spring for providing return movement to the valve spool after the drive mechanism has provided movement to the valve spool. Optionally, the housing is provided with at least one slot for removably attaching the cartridge to the chemical injection system. Optionally, the chemical injection system is handheld. Optionally, the chemical injection system is non-handheld.

There is thus provided in accordance with some aspects of the invention, a method of using a chemical injection system, comprising: moving a purge rod; and, pumping solvent over an outlet of the chemical injection system by the moving of the purge rod. Optionally, the moving of the purge rod causes mechanical pumping of the solvent.

There is thus provided in accordance with some aspects of the invention, A method of breaking reacted chemical build-up in a chemical injection system, comprising: commencing an over-travel movement of a purge rod towards an outlet of the chemical injection system thereby breaking any reacted chemical build-up; and, moving the purge rod away from the outlet. Optionally, the movement occurs at the beginning of an injection cycle of the chemical injection system.

There is thus provided in accordance with some aspects of the invention, a method of urging a chemical inlet port towards a valve spool located in a cartridge, comprising: providing at least one o-ring to an exterior surface of the chemical inlet port; installing the cartridge in a substance delivery apparatus, wherein by the installing the cartridge the at least one o-ring becomes compressed; and, wherein the compressed o-ring urges the chemical inlet port towards the valve spool. Optionally, the at least one o-ring is constructed of rubber.

There is thus provided in accordance with some aspects of the invention, a valve spool of a chemical injection system, comprising: a perforated solvent groove, wherein the perforated solvent groove is provided with at least one hole for the transmission of solvent therethrough. Optionally, a plurality of holes is equally spaced around a circumference of the solvent groove. Optionally, the at least one hole is located at the thinnest portion of the groove in order to reduce the likelihood of reacted chemical buildup in the hole. Optionally, the at least one hole is located upstream of a tip of the chemical injection system such that upon transmission of solvent through the at least one hole, the solvent flows over the tip.

There is thus provided in accordance with some aspects of the invention, a handheld chemical injection system, comprising: a motor; a drive mechanism operatively connected to the motor; and, more than one control mechanism for controlling an aspect of operation of the handheld chemical injection system. Optionally, at least one control mechanism is a trigger for activating at least a portion of the chemical injection system. Optionally, at least one control mechanism is an operational mode selector switch. Optionally, at least one control mechanism is an injection operation profile selector switch. Optionally, at least one control mechanism is a bolus size selector switch.

There is thus provided in accordance with some aspects of the invention, a chemical injection system, comprising: a handheld portion, wherein the handheld portion injects chemicals; and, a display located on the handheld portion, wherein the display is operable to provide information regarding the chemical injection system. Optionally, the information relates to an injection cycle. Optionally, the information relates to the amount of at least one supply material remaining in at least one supply reservoir. Optionally, the at least one supply material is a chemical. Optionally, the at least one supply material is a solvent.

There is thus provided in accordance with some aspects of the invention, a method of using a chemical injection system, comprising: moving a purge rod towards an “open” position; rotationally aligning a valve spool upon attainment of the “open” position, wherein a chemical pass-through port on the valve spool is aligned with a chemical inlet port located on a housing of the valve spool; moving the purge rod towards a “closed” position; and, misaligning the valve spool upon the moving the purge rod towards the “closed” position. In some exemplary embodiments of the invention, the method further comprises flowing solvent in the chemical injection system for cleansing.

### BRIEF DESCRIPTION OF THE DRAWINGS

Exemplary non-limiting embodiments of the invention are described in the following description, read with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a block diagram depicting major components of a substance injection system, in accordance with an exemplary embodiment of the invention;

FIG. 2 is a perspective view of a closed substance injecting apparatus in cartridge form, in accordance with an exemplary embodiment of the invention;

FIG. 3 is a perspective view of a closed substance injecting apparatus in cartridge form with the housing removed, in accordance with an exemplary embodiment of the invention;

FIG. 4A is a cross-sectional view of a substance injecting apparatus in a closed position on the plane of the chemical inlets, in accordance with an exemplary embodiment of the invention;

FIG. 4B is a cross-sectional view of a substance injecting apparatus in an open position on the plane of the chemical inlets, in accordance with an exemplary embodiment of the invention;

FIG. 5A is a cross-sectional view of a substance injecting apparatus in a closed position on the plane of the solvent inlet, in accordance with an exemplary embodiment of the invention;

FIG. 5B is a cross-sectional view of a substance injecting apparatus in an open position on the plane of the solvent inlet, in accordance with an exemplary embodiment of the invention;

FIG. 6 is a cutaway view of a linear drive mechanism, in accordance with an exemplary embodiment of the invention;

FIG. 7 is a cutaway view of a rotary drive mechanism, in accordance with an exemplary embodiment of the invention;

FIG. 8 is a flowchart describing a method for operating a substance injecting apparatus, in accordance with an exemplary embodiment of the invention;

FIG. 9 is a perspective view of a handheld substance delivery apparatus, in accordance with an exemplary embodiment of the invention; and,

FIG. 10 is a cutaway view of a handheld substance delivery apparatus showing the substance injecting apparatus and the drive mechanism in accordance with an exemplary embodiment of the invention.

### DETAILED DESCRIPTION OF EXEMPLARY EMBODIMENTS

As described above, a number of approaches such as the use of solvents and mechanical cleansing are used in the packing material manufacturing industry for reducing the effects of reacted chemical build-up. Nevertheless, these solutions are not absolutely perfect and performance degradation and eventual system shut down can still occur.

For example, in Sperry the solvent flows through the mixing chamber chemical ports in the reverse direction from the chemical flow, therefore any reactants in the chemical ports are transported to a space between the wall of the mixing chamber and the housing where they can build up over time. In addition, the tolerance of the purge rod diameter to the mixing chamber wall is critical in maintaining the proper solvent flow to the chemical ports and the tip of the gun. If this gap becomes too large, solvent will not flow to the chemical ports nor will it be retained at the tip of the gun.

Regarding Keske, the design recirculates the solvent and has no provision for wetting the tip of the gun with solvent to reduce buildup on the tip. Further compounding this shortcoming, if the purge rod sticks to the tip of the mixing chamber, the mixing chamber will pull back simultaneously with the purge rod causing the reactants to flow around and behind the tip of the purge rod, jamming the gun.

In Petcen, the mixing chamber is typically made of Teflon or similar material that cold flows under pressure. The mixing chamber is placed under pressure by the use of Bellville washers stacked against one end. This causes the material to squeeze around the purge/valve rod which is in an interference fit. The rod then forms a seal against the wall of the mixing chamber. Pulling the rod back exposes the chemical inlets and starts the flow of chemicals. With time however the rod may get a build up of chemical reactants, no longer providing a good seal, hence the need for scraping the exterior surface of the rod in an attempt to keep it clean. For solvent-free, non-moving mixing chamber designs, such as the Petcen design, the lifetime is expected to be around 50,000 injection cycles before requiring repair or replacement.

In contrast, designs with a moving mixing chamber and solvent cleaning such as described herein can be expected to last around 250,000 cycles before requiring repair or replacement. Furthermore, when repair or replacement becomes a necessity, it is naturally preferable to restore the system to operational status with as much ease and as little cost as is reasonably possible in a short amount of time. One way of doing this is by providing easily interchangeable and replaceable parts for the most at risk components of the chemical injection system, such as a cartridge which includes the mixing chamber where the component chemicals are reacted and the outlet where the resultant packing material is expelled. It should be noted that these and other advantages of the present invention are achieved with respect to some exemplary embodiments of the invention and not necessarily others.

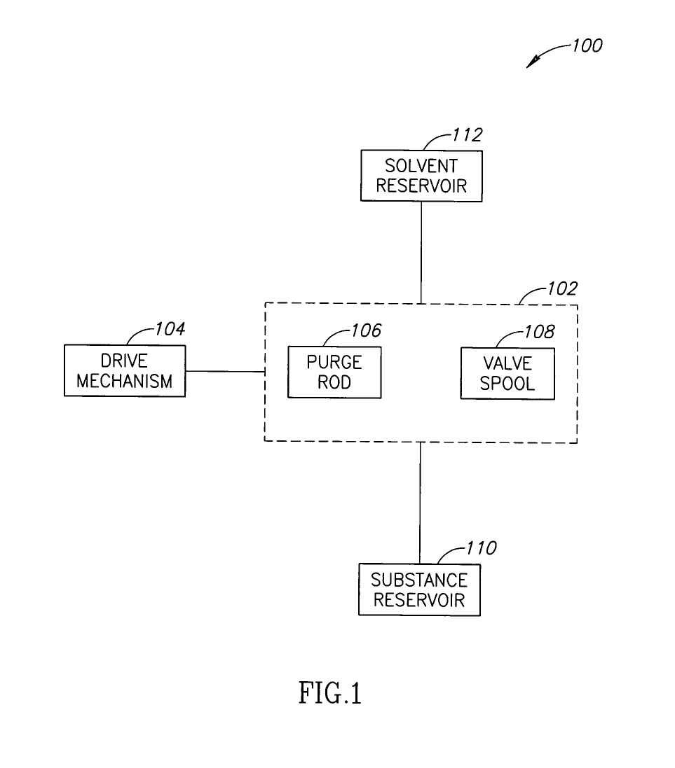

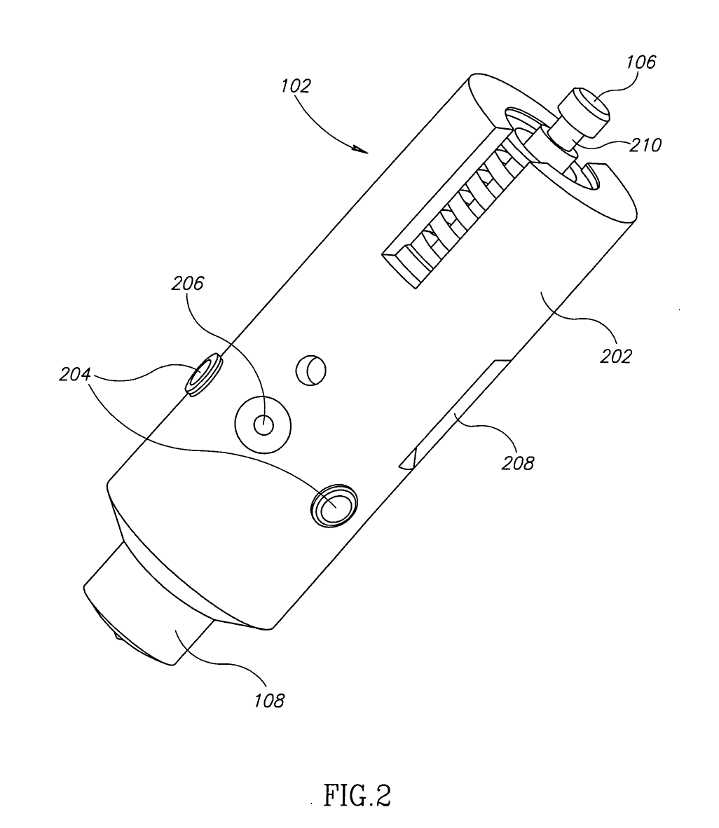

Referring to FIG. 1, a block diagram is provided depicting major components of a chemical injection system 100, in accordance with an exemplary embodiment of the invention. A cartridge 102 is provided to chemical injection system 100 which is, in contrast to cleaning out the whole system upon debilitating chemical build-up or replacing multiple and individual parts, relatively easy and inexpensive to replace in order to restore chemical injection system 100 operation. In an exemplary embodiment of the invention, cartridge 102 is provided with a purge rod 106 and a valve spool 108. Purge rod 106 fits within a lumen defined by generally cylindrical valve spool 108, as described in more detail with respect to FIG. 2 below. It should be noted in some exemplary embodiments of the invention cartridge 102 is capable of interchangeable use with different machines of the same configuration and/or different machines with different configurations.

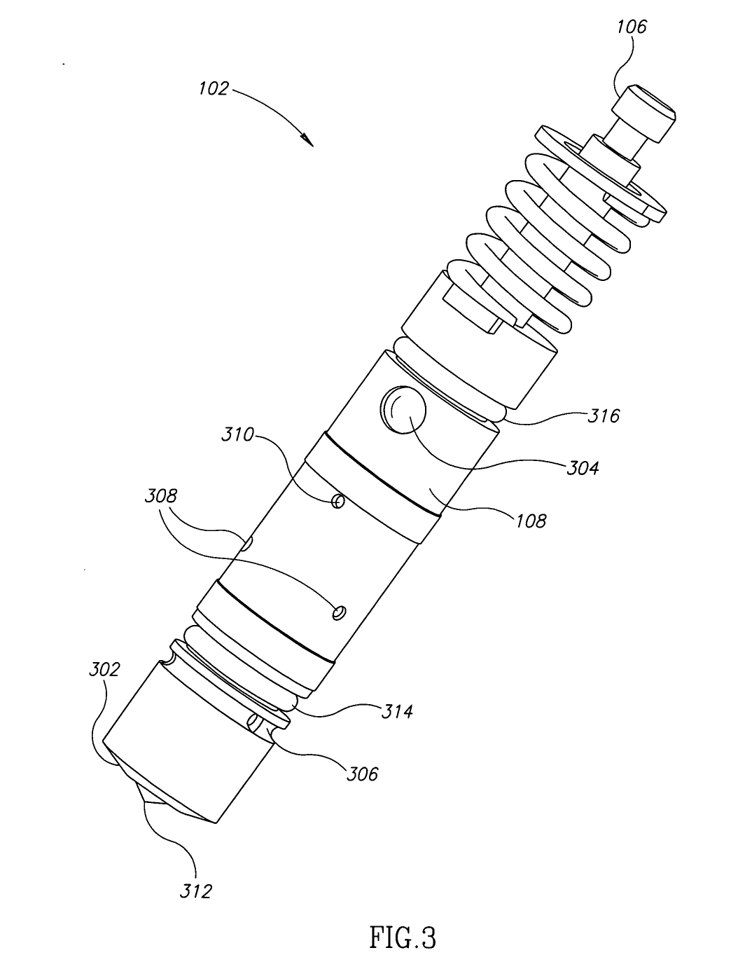

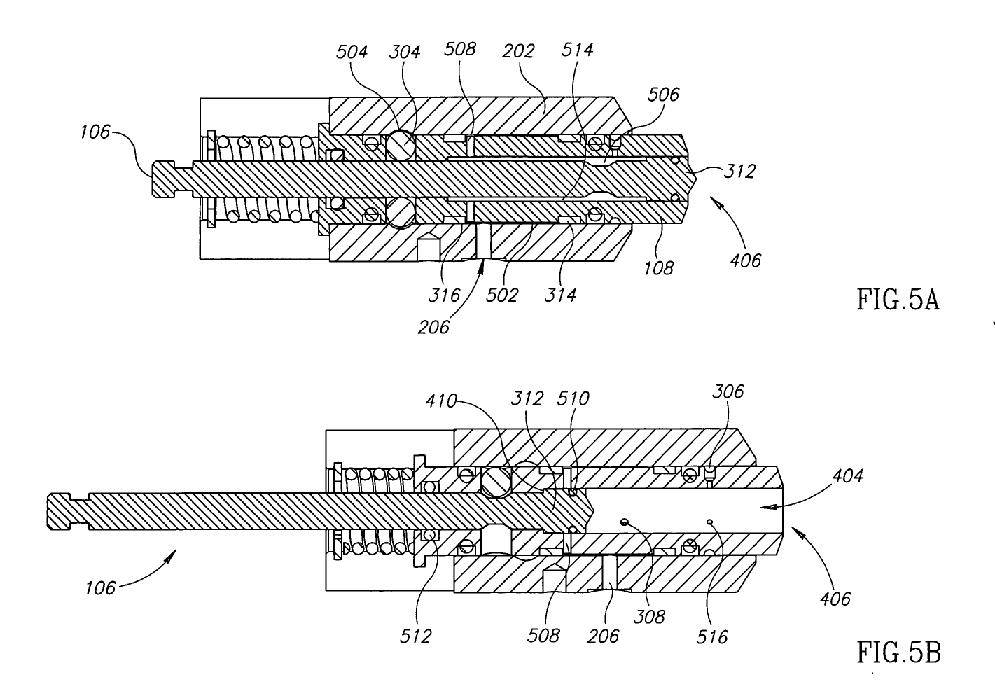

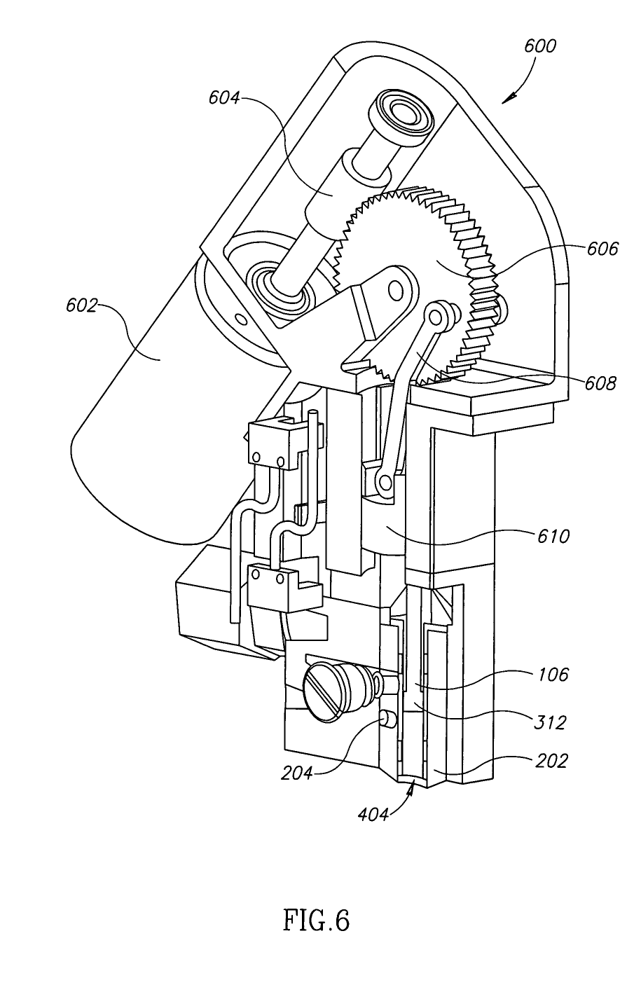

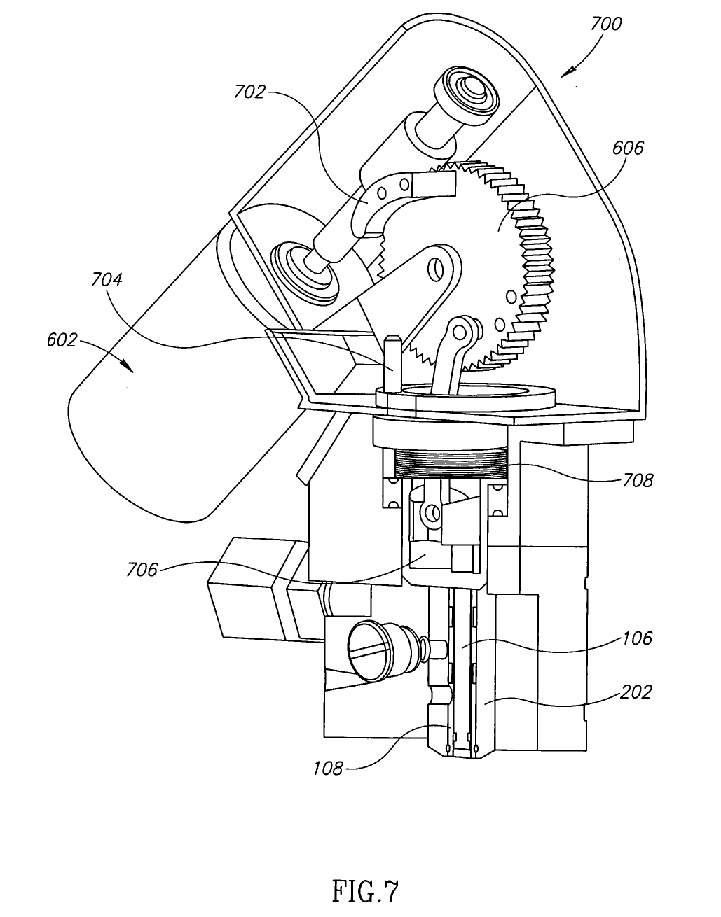

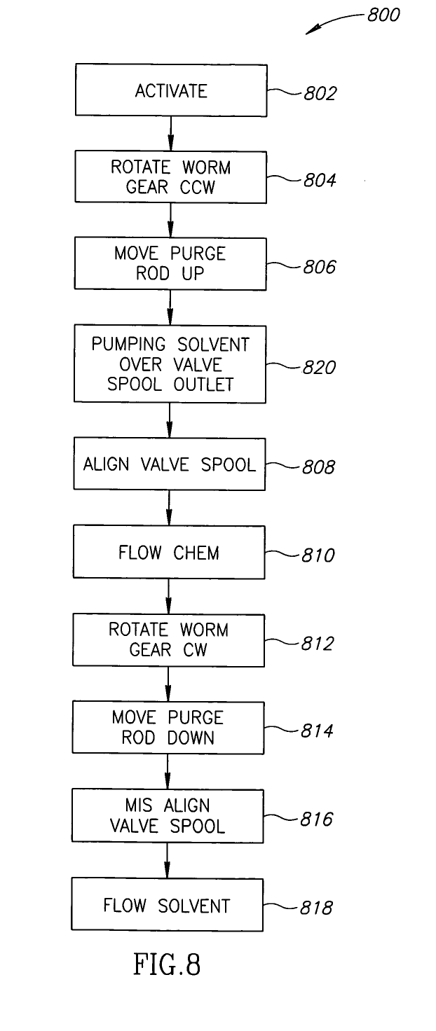

To briefly describe chemical injection system 100 operation (e.g. an injection cycle), a drive mechanism 104 operates to cause motion of purge rod 106 within valve spool 108. The method of operation of chemical injection system is described in more detail with respect to FIG. 8, below, but generally speaking chemical injection system 100 is placed in an “open” position by moving linearly and/or rotating valve spool 108 such that pass-through ports 308 on valve spool 108 align with chemical inlet ports 204 provided to a cartridge housing 202. Linear and rotational drive mechanisms 600, 700 are described herein with respect to FIGS. 6 and 7. Once the pass-through ports 308, shown in FIG. 3, are aligned with the chemical inlet ports 204, chemicals can flow from at least one reservoir 110 into a mixing chamber defined by the lumen of valve spool 108 and a tip of purge rod 106 for reacting. As chemical injection system 100 moves back towards a “closed” position, the tip of the purge rod forces reacted chemicals out of a cartridge outlet which, in an exemplary embodiment of the invention, is located at an end 302 of the lumen opposite the direction of travel of purge rod 106 when moving into the “open” position. In an exemplary embodiment of the invention, solvent is provided to cartridge 102 from a solvent reservoir 112 in order to cleanse cartridge 102 of reacted chemicals, as described in more detail with respect to FIGS. 5A and 5B below. Optionally, solvent is flushed over the end 302 of cartridge 102 at the commencement of the injection cycle, also described in more detail with respect to FIGS. 5A and 5B.

### Exemplary Cartridge

Referring to FIG. 2, a perspective, external view of a cartridge 102 is shown, in accordance with an exemplary embodiment of the invention. In an exemplary embodiment of the invention, the cartridge's nature is such that it is capable of quick, easy and relatively inexpensive replacement and/or interchangeability with other cartridges which perform essentially the same function. It can be seen that in an exemplary embodiment of the invention, cartridge is generally defined by a housing 202 which encloses valve spool 108 and purge rod 106, as shown in more detail in FIG. 3. Housing 202 also provides structure for mounting chemical inlet ports 204, in some exemplary embodiments of the invention. Although two chemical inlet ports 204 are depicted in FIG. 2, it should be understood that any number of ports are optionally used depending on the application of the substance injection system. In an exemplary embodiment of the invention, housing 202 also provides for a solvent inlet port 206, which is used to introduce solvent into cartridge 102 for cleansing. Solvent inlet port 206 is optionally located anywhere on housing whereby solvent flow through port 206 will emerge in a cavity 502, described below with respect to FIG. 5A.

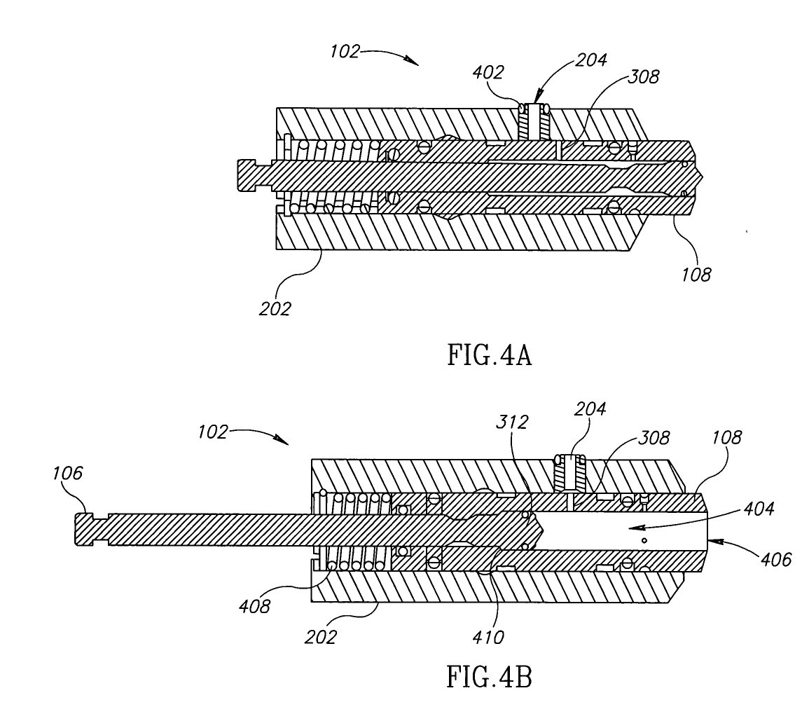

Due to the interchangeable and replaceable nature of cartridge 102, it is desirable in some exemplary embodiments of the invention that it is easily attached, removed and/or serviced in the field. In an exemplary embodiment of the invention, cartridge 102 is provided with at least one mechanism for removably affixing cartridge to a substance injection machine. Attachment is optionally achieved by a snap-in type of mechanism. Optionally, at least one slot 208 is provided into which a tool can be inserted to detach cartridge 102 from the machine. By inserting a tool, for example a screwdriver, into slot 208 cartridge 102 can be pried out of the machine in which it is mounted. It should be understood that while slot 208 is shown, any mechanism known in the art for removably affixing one component to another could optionally be used additionally or alternatively to slot 208 for attaching or removing cartridge 102 from a machine. Another feature of cartridge 102 which optionally provides for simplifying attachment, removal and/or servicing includes a groove 210 on purge rod 106 on an end proximal to drive mechanism 104. While this groove 210 provides an interface to drive mechanism 104, as described with reference to FIGS. 6 and 7, it also allows easy disassembly of purge rod 106 for cleaning and/or replacement of a spring-side o-ring 512 located at the top of the mixing chamber and shown in FIGS. 4A, 4B, 5A and 5B. Optionally, groove 210 allows for the easy replacement of a tip o-ring 510 located at the tip of purge rod 106.

FIG. 3 shows a perspective view of cartridge 102 with housing 202 removed, in accordance with an exemplary embodiment of the invention. Valve spool 108 is seen more clearly in FIG. 3 and it can be seen that in some exemplary embodiments of the invention, a tip 312 of purge rod 106 can over-travel to extend slightly past an outlet end 302 of valve spool 108. The over-travel feature is described in more detail with respect to FIGS. 6 and 7. In some exemplary embodiments of the invention, valve spool 108 is provided with at least one chemical pass-though port 308 the number of which optionally corresponds to the number of chemical inlet ports 204 used. As described below, alignment of a chemical pass-through port 308 with a chemical inlet port 204 allows for introduction of a chemical into the lumen of valve spool 108. Valve spool 108 is optionally also provided with at least one solvent pass-through port 310 for introducing solvent into the lumen of valve spool 108. Solvent flow will be described in more detail with respect to FIGS. 5A and 5B, however FIG. 3 can be used to show exterior o-rings 314, 316 and a solvent groove 306 which facilitate the cleansing of cartridge 102 using solvent during an injection cycle. In an exemplary embodiment of the invention, at least one precision metal ball 304 is used to prevent premature motion of valve spool 108 during an injection cycle, and shown in more detail in FIGS. 5A and 5B.

### Exemplary Chemical and Solvent Flow

Referring to FIG. 4A, a cross-sectional view of cartridge 102 in the “closed” position is shown, in accordance with an exemplary embodiment of the invention. This cross-sectional view is in the plane of a chemical inlet port 204. In addition, the embodiment depicted in FIGS. 4A and 4B is that of a linear drive mechanism rather than rotational. FIG. 4A depicts a “closed” position cartridge 102 indicated by chemical pass-through port 308 not being aligned with chemical inlet port 204. In this condition, valve spool 108 obstructs chemical inlet port 204 such that little or no chemical can enter into cartridge 102.

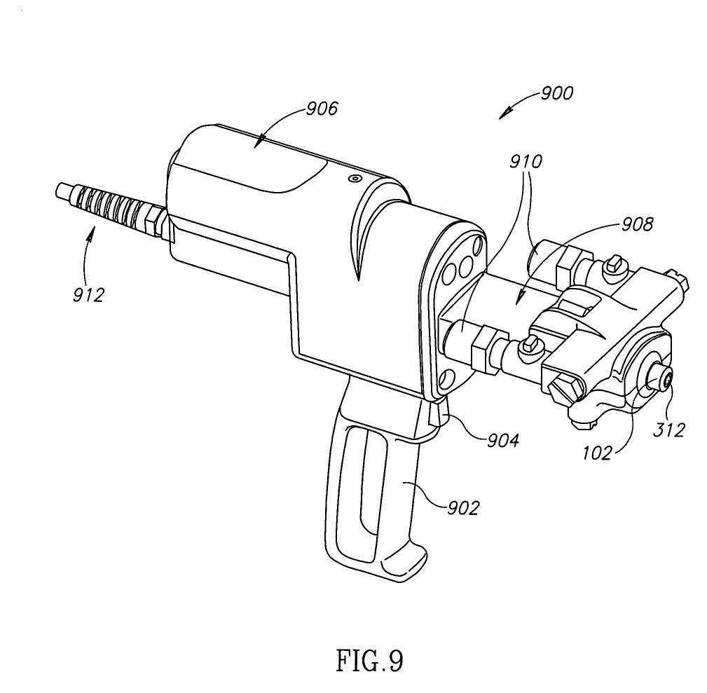

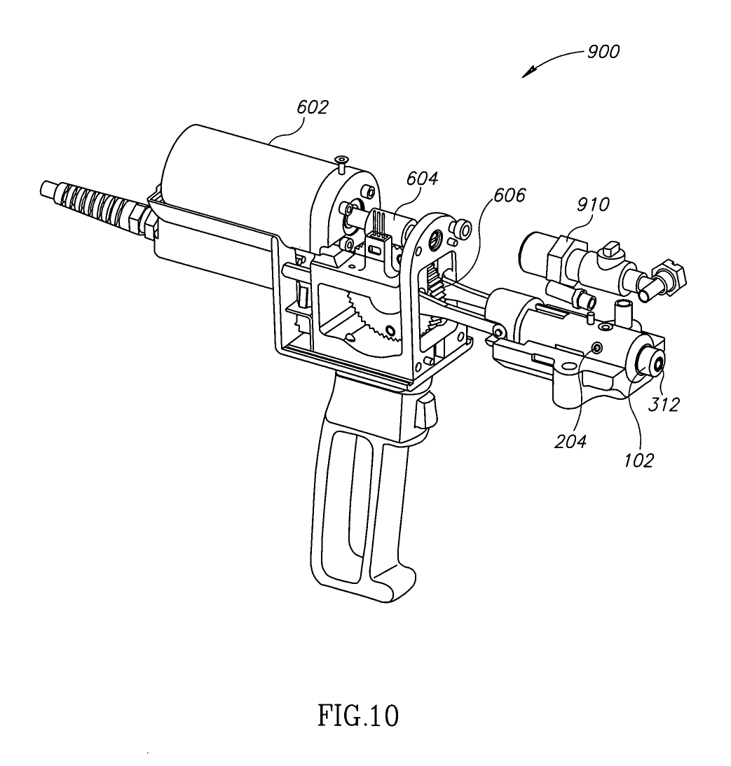

In some exemplary embodiments of the invention, at least one o-ring 402 is used to urge chemical inlet port 204 against valve spool 108 in order to form a better seal against chemical leakage into cartridge 102. Optionally o-ring 402 is constructed of an elastic material such as rubber and/or plastic. In some exemplary embodiments of the invention, at least one o-ring is placed on the exterior of chemical inlet port 204. When cartridge 102 is installed in a substance delivery apparatus, such as handheld substance delivery apparatus 900 described with respect to FIGS. 9 and 10, the at least one o-ring is compressed such that it urges chemical inlet port 204 towards valve spool 108. Alternatively or additionally, upon manufacture o-ring 402 is biased such that when in position it urges chemical inlet port 204 against valve spool 108.

FIG. 4B shows the same cross-sectional view as FIG. 4A but with cartridge 102 in an “open” position such that chemical can flow into a mixing chamber 404, in accordance with an exemplary embodiment of the invention. Valve spool 108 is moved into the “open” position by drive mechanism 104 moving purge rod 106, shown in more detail in FIG. 6. In an exemplary embodiment of the invention, as purge rod 106 moves to the left in FIG. 4B, purge rod tip 312 catches a ledge 410 on valve spool 108 which is at least slightly smaller in diameter than tip 312. Sustained motion of purge rod 106 to the left, or “open” position, pulls valve spool 108 along the longitudinal axis of cartridge in a linear motion until such time as chemical inlet port 204 is aligned with chemical pass-through port 308 located on valve spool 108. Chemicals are then free to enter into mixing chamber 404 and are eventually expelled out of a cartridge outlet 406 at least by the return motion of purge rod 106. Optionally, gravity and/or the force of the reaction assist with the expulsion of the chemicals. In some exemplary embodiments of the invention, a spring 408 is used to resist movement into the “open” position and to assist movement into the “closed” position. In rotational embodiments of the invention, such as described in FIG. 7, valve spool 108 is not linearly positioned using purge rod 106 as described herein, but rather is rotated by drive mechanism 104 so that chemical pass-through port 308 is aligned with chemical inlet port 204.

In an exemplary embodiment of the invention, the configuration of the chemical and solvent inlet ports and pass-through ports is designed such that taking into account the cyclical timing of purge rod 106 and valve spool 108, and thereby the “open” and “closed” positions, solvent cleansing is provided to components of cartridge 102 which are at risk of chemical buildup. For example, solvent is provided to cartridge 102 through solvent inlet port 206 and is retained in a cavity 502 whereby when cartridge 102 moves towards a “closed” position, solvent can flow through chemical pass-through ports 308, thereby cleansing them, which are in fluid communication with cavity 502, as is described below in more detail.

Referring to FIG. 5A, a “closed” cross-sectional view of cartridge 102 provided with linear valve spool 108 motion is shown, in accordance with an exemplary embodiment of the invention. This cross-sectional view is in the plane of a solvent inlet port 206. In an exemplary embodiment of the invention, chemical flows towards outlet 406 of the mixing chamber. FIG. 5A is cut to show the flow of the solvent not the flow of the chemicals, in accordance with an exemplary embodiment of the invention. Solvent optionally enters cartridge 102 through solvent inlet port 206 located in housing 202. In some exemplary embodiments of the invention, solvent inlet port 206 is variable in interior diameter for controlling solvent flow into cavity 502. Optionally, solvent inlet port 206 is a replaceable and/or interchangeable part with other solvent inlet ports of varying interior diameter. In an exemplary embodiment of the invention, solvent then fills cavity 502 located between an outer wall of valve spool 108 and an inner wall of housing 202 and through at least one inner solvent port 508 into a space 514 defined by purge rod 106, tip o-ring 510, the inner circumference of valve spool 108 and a spring-side o-ring 512. Exterior o-ring 316 near the left end of valve spool 108 and exterior o-ring 314 near the right end of valve spool 108 prevent the solvent from exiting cavity 502.

Referring to FIG. 5B, an “open” cross-sectional view of FIG. 5A is shown, in accordance with an exemplary embodiment of the invention. With purge rod 106 moved into an “open” position, as shown in FIG. 5B, solvent flow is essentially halted because purge rod tip 312 blocks inner solvent port 508 and chemical pass-through ports 308 are aligned with chemical inlets 204 preventing the flow of solvent from cavity 502 into mixing chamber 404. As cartridge 102 moves towards a “closed” position, purge rod 106 starts to move to the right and valve spool 108 moves with it (due to the action of compressed spring 408) until chemical pass-through ports 308 are no longer aligned with chemical inlets 204, stopping chemical flow. In this position, chemical pass-through ports 308 are now open to the solvent trapped in cavity 502. It is important to note that, in some exemplary embodiments of the invention, the purge rod tip 312 is sized linearly to block solvent ports 508 until purge rod 106 begins to pass chemical pass-through ports 308, which in turn forces solvent flow through chemical pass-through ports 308. Solvent now flows through chemical pass-through ports 308 flushing purge rod tip 312 and mixing chamber 404 until purge rod 106, which continues to move to the right while valve spool 108 motion stops, passes chemical pass-through ports 308. The solvent used to wash purge rod tip 312 exits cartridge 102 from outlet 406 of cartridge 102. In some exemplary embodiments of the invention, at least 1 cc of solvent is used for cleansing. Optionally, up to 3 cc of solvent is used for cleansing.

In an exemplary embodiment of the invention, solvent flow subsequently begins to fill the increasing space 514 that is created between the exterior of purge rod 106 and the interior of valve spool 108 as purge rod 106 continues to the right. This is at least partially due to the seal at the bottom of purge rod 106 created by tip o-ring 510 which creates a vacuum-like effect in space 514 and in some exemplary embodiments of the invention is also due to the pressure provided by the solvent pump, pumping the solvent into cartridge 102. In some exemplary embodiments of the invention, no significant amounts of solvent exit cartridge 102 at this stage. When tip o-ring 510 passes at least one hole 516 provided to solvent groove 306, solvent can now flow from space 514 through hole 516 and to an exterior space between housing 202 and valve spool 108 but outside of exterior o-ring 314 such that the solvent can continue to flow along the exterior of valve spool 108 and out of cartridge 102 cleansing the exterior surfaces of the outlet 406 end of valve spool 108 and purge rod tip 312 in the process. In an exemplary embodiment of the invention, solvent groove 306 helps to retain solvent around hole 516 thereby keeping hole 516 unobstructed by reacted chemicals and also optionally reducing the wall thickness of valve spool 108 which reduces the length of hole 516 and in turn reduces the amount of reacted chemicals that can be trapped in hole 516. In some exemplary embodiments of the invention, a plurality of holes 516 is located in solvent groove 306. Optionally, holes 516 are equally spaced around solvent groove 306 to provide uniform distribution of solvent flow over tip 312 of purge rod 106 and/or outlet 406. In an exemplary embodiment of the invention, solvent continues to flow until a solvent pump (not pictured) pumping solvent from solvent reservoir 112 is stopped.

When cartridge now moves again towards an “open” position, purge rod 106 starts traveling to the left compressing any solvent that has filled the space 514 between purge rod 106 and valve spool 108. This causes a pumping action on the solvent and causes some solvent to exit through hole 516, and thus over tip 312, at the time cartridge 102 opens providing additional cleansing of tip 312. Pumping a small amount of solvent before the injection cycle makes sure that the surfaces have a layer of solvent on them to reduce the possibility of subsequent build up. This pumping is particularly useful if there has not been an injection for some time and at least some of the solvent from the end of the previous cycle may have evaporated.

### Ball Locking Mechanism

Usage of a ball locking mechanism helps overcome inadvertent movement of the mixing chamber, such as might occur using the Keske design described above. In an exemplary embodiment of the invention, ball locking mechanism shown in FIGS. 5A and 5B allows movement of mixing chamber only when intended. At least one precision metal ball 304 is shown nested in a spool ball groove 504, the interplay between the two preventing movement of valve spool 108 until rod ball-bearing groove 506 moves opposite spool ball groove 504 such that precision metal ball 304 can move out of spool ball groove 504 and into rod ball groove 506, freeing valve spool 108 to move to the left and into an “open” position as described above. It should be noted that rod ball groove is positioned on purge rod 106 such that it will be opposite spool ball groove at the same time or before purge rod tip 312 contacts ledge 410 in valve spool 108, described with respect to FIG. 4B, which is at least slightly smaller in diameter than the tip 312. It should be noted that a precision metal ball mechanism may not necessarily be used with a rotational embodiment of the invention.

### Exemplary Drive Mechanisms

Referring to FIG. 6, an exemplary linear drive mechanism 600 is shown which, in some exemplary embodiments of the invention, provides motive force to valve spool 108 via purge rod 106. Linear drive mechanism 600 is powered by a motor 602 which can be any motor known to those skilled in the art, for example an electric motor. Optionally, motor 602 is hydraulic. Optionally, motor 602 is pneumatic. Motor 602 is operationally connected to purge rod 106 such that movement is imparted to purge rod 106 moving it up and down linearly along the longitudinal axis of cartridge 102. In an exemplary embodiment of the invention, motion is translated from motor 602 to purge rod 106 using a worm 604 and worm gear 606 arrangements. In an exemplary embodiment of the invention, worm gear 606 is connected to a connecting rod 608 which is in turn connected to a linear slider 610 fastened around purge rod groove 210. It should be noted that this operative connection configuration is only by way of example, and that any configuration which would impart motion to purge rod 106 from motor 602 would be acceptable. In an exemplary embodiment of the invention, rotation of worm 604 causes worm gear 606 to rotate counter clockwise from its lowest position resulting in a linear movement of linear slider 610 upwards (according to the orientation of this Figure, this would equate to leftwards motion in FIGS. 4A-5B), and since they are connected, purge rod 106 also moves up in valve spool 108.

A potential advantage of this configuration is that at this point mechanical leverage is enormous, helping to overcome any friction and reacted chemical sticking. Optionally, there is at least a slight motion downwards called “over-travel” before moving upwards in order to help break sticking forces due to reacted chemical build-up. In some exemplary embodiments of the invention, worm 604 can be locked so no motion is imparted to worm gear 606, thereby optionally locking drive mechanism 104 and other operative parts of chemical injection system 100.

After a certain amount of linear travel by purge rod 106, purge rod 106 hits ledge 410 (not shown in FIG. 6) on valve spool 108 and starts pulling it upwards also, compressing spring 408. When purge rod 106 is at its uppermost, “open” position, chemical pass-through ports 308 are aligned with chemical inlets 204 allowing chemicals to enter mixing chamber 404, collide, and produce a resultant reacted chemical, which then flows and/or is purged by purge rod 106 downwards out of cartridge 102.

In some exemplary embodiments of the invention, the desired amount of chemicals is determined by a controller. Optionally, a user of chemical injection system 100 manually determines a desirable amount of chemicals. In an exemplary embodiment of the invention, after the desired amount of chemicals are reacted and/or injected into a receptacle, worm gear 606 is turned clockwise to perform a downwards movement of linear slider 610, and therefore the attached purge rod 106, towards a “closed” position. Valve spool 108 is pushed down by spring 408 and misaligns chemical pass-through ports 308 with chemical inlets 204, resulting in ceasing chemical flow into mixing chamber 404. In an exemplary embodiment of the invention, solvent is pumped into cavity 502 and at least some of it flushes through inner solvent port 508 into space 514, as described with respect to FIGS. 5A and 5B. As purge rod tip 312 moves downwards to a “closed” position, tip o-ring 510 wipes off the interior surface of valve spool 108 providing mechanical assistance to the solvent with cleansing, in accordance with some exemplary embodiments of the invention. It is noted that in an exemplary embodiment of the invention, linear drive mechanism 600 is provided with the greatest amount of mechanical leverage at the most critical times, at the beginning to break sticking due to reacted chemical build-up and as cartridge 102 nears the “open” position to counteract the increasing forces of spring 408. In an exemplary embodiment of the invention, this is due to the motion of connecting rod 608 in relation to worm gear 606 during the injection cycle. It is noted that towards the beginning of the injection cycle, as worm gear 606 begins to rotate relatively little vertical motion is imparted to connecting rod 608, as a larger component of the motion is horizontal, thus reserving more mechanical leverage for breaking any sticking due to chemical build-up. As the cycle progresses, and worm gear 606 turns, there is less horizontal motion and more vertical motion until at some point towards the end the trend shifts back towards more horizontal motion than vertical motion, which provides the additional leverage for compressing spring 408. That is, in some exemplary embodiments of the invention, the vertical motion and/or mechanical leverage could be graphed in a sinusoidal-like manner.

In some exemplary embodiments of the invention, feedback is provided to chemical injection system 100 in order to help an operator and/or chemical injection system 100 determine the position and/or operational status of cartridge 102. Feedback is optionally provided by at least one sensor located in linear drive mechanism 600. Optionally bi-polar magnets are used in conjunction with a sensor in order to provide feedback. In an exemplary embodiment of the invention, the magnets are located on worm gear 606. For example, a first magnet is optionally oriented with its south pole closer to the sensor and the second magnet is oriented with its north pole closer to the sensor. In an exemplary embodiment of the invention, when the first magnet is rotated in front of the sensor it indicates one end of travel and when the second magnet is rotated in front of the sensor the other end of travel is indicated. A latch is optionally provided to the sensor to maintain its last state until the other bi-polar magnet switches it.

Referring to FIG. 7, an exemplary rotational drive mechanism 700 is shown which, in some exemplary embodiments of the invention, provides motive force to valve spool 108 without using purge rod 106, in contrast to linear drive mechanism 600. While motion is optionally imparted to purge rod 106 in a manner similar to the linear drive mechanism embodiment, in an exemplary embodiment of the invention, valve spool 108 is rotated around its longitudinal axis instead of moved linearly as with the linear drive mechanism embodiment. It should be noted that any operative mechanical configuration to provide rotation movement to valve spool 108 is capable of use with the present invention, for example by using a threaded mechanism to provided rotary movement. For example, purge rod 106 could be configured with a thread-like groove near purge rod tip 312 that would engage tabs located on valve spool 108 such that when purge rod 106 is moved, the valve spool tabs would engage the grooves of purge rod tip 312 and cause valve spool 108 to rotate as the tabs followed the groove.

However in some exemplary embodiments of the invention, a striker 702 is attached to worm gear 606 wherein when worm gear 606 rotates counter-clockwise, striker 702 urges against a valve spool actuation peg 704. Valve spool actuation peg 704 is in turn connected to a rotary slider 706 which is connected to valve spool 108, in accordance with some exemplary embodiments of the invention. Sustained urging of striker 702 against valve spool actuation peg 704 as worm gear 606 rotates counter-clockwise causes rotary slider 706 to rotate, and hence valve spool 108 along with it. Counter-clockwise motion of worm gear 606 also results in rotation of valve spool 108 against a torsion spring 708 whose function is described below.

It should be noted that striker 702 is optionally positioned on worm gear 606 such that striker 702 will contact valve spool actuation peg 704 at the appropriate time in the injection cycle to effectuate chemical flow into mixing chamber 404 (not shown). After a certain amount of linear travel by purge rod 106, chemical pass-through ports 308 become unobstructed by purge rod 106 and, in an exemplary embodiment of the invention, striker 702 substantially concurrently hits valve spool actuation peg 704 and starts rotating it about the longitudinal axis of cartridge 102. When purge rod 106 is at most upper position (according to the orientation of this Figure), and valve spool 108 has been fully rotated into an “open” position, chemical pass-through ports 308 are aligned with chemical inlets 204 allowing chemicals to enter mixing chamber 404, collide, and produce foam, flowing downwards out of mixing chamber 404. After a desired amount of chemicals are discharged into mixing chamber 404, worm gear 606 is turned clockwise to effectuate a downwards movement of linear slider 610 and hence the attached purge rod 106. Due to torsion spring 708, valve spool 108 is rotated back towards its original “closed” position and misaligns chemical pass-through ports 308 with chemical inlets 204, resulting in the cessation of chemical flow into mixing chamber 404. In some exemplary embodiments of the invention, rotation of valve spool 108 is only enough to misalign chemical pass-through ports 308 with chemical inlets 204 to stop the flow of chemical.

In an exemplary embodiment of the invention at this point in the injection cycle, solvent is pumped into cavity 502 and some of it flushes through chemical pass-through port 308 into mixing chamber 404, before purge rod 106 passes chemical pass-through ports 308, thereafter stopping solvent flow directly out of cartridge 102 via mixing chamber 404. In some exemplary embodiments of the invention, some solvent also passes through at least one inner solvent port 508 to cleanse parts of purge rod 106 and valve spool 108 on the spring-side of purge rod tip 312. In an exemplary embodiment of the invention, the remainder of the pumped solvent fills and soaks gaps between housing 202, valve spool 108 and purge rod 106, including chemical pass-through ports 308, as shown more clearly in FIGS. 5A and 5B.

As described above, it is noted that in an exemplary embodiment of the invention, rotational drive mechanism 700 is provided with the greatest amount of mechanical leverage at the most critical times, especially at the beginning to break sticking due to reacted chemical build-up. In some exemplary embodiments of the invention, feedback is provided to chemical injection system 100 in order to help an operator and/or chemical injection system 100 determine the position and/or operational status of cartridge 102. This feedback can be used, for example, to signal that the cartridge 102 is in a position to be removed from chemical injection system 100. In some exemplary embodiments of the invention, this feedback is used to indicate that purge rod 106 has reached its limit of travel.

In an exemplary embodiment of the invention, motor 602 is optionally mounted at any tangential angle to worm gear 606 due to the use of worm 604 for driving worm gear 606.

### Exemplary Method of Operation

Referring to FIG. 8, an exemplary method of operation, or an injection cycle, for chemical injection system 100 is shown in flowchart 800. Chemical injection system 100 is activated (802) in order to commence operation of at least a drive mechanism 600, 700 and optionally pumps associated with substance reservoir 110 and solvent reservoir 112. Optionally, chemical injection system is activated (802) using a trigger, for example in association with a handheld substance delivery apparatus, such as shown in FIG. 9. In an exemplary embodiment of the invention, activation (802) of a drive mechanism 600, 700 causes worm gear 606 to rotate counter-clockwise(804) causing purge rod 106 to move towards an (806) “open” position and valve spool 108 to align (808) chemical pass-through ports 308 with chemical inlet ports 204. As chemical pass-through ports 308 with chemical inlet ports 204 align (808) chemicals flow (810) into mixing chamber 404. After a desired amount of chemicals are discharged into mixing chamber 404, worm gear 606 is rotated clockwise (812) to effectuate movement of purge rod 106 towards a “closed” position (814). Movement of purge rod 106 towards a “closed” position (814) misaligns (816) valve spool, as described herein, such that chemical inlets 204 are not aligned with chemical pass-through ports 308 effectively halting chemical flow into mixing chamber 404. In some exemplary embodiments of the invention, solvent flow commences (818) once purge rod 106 begins movement towards a “closed” position (814). Optionally, solvent is pumped (820) over valve spool outlet 406 out of holes 516 upon the beginning of movement towards an “open” position (806). Optionally, chemical injection system 100 is run without pumping chemicals into cartridge 102 in order to perform at least one injection cycle using only solvent for cleaning purposes.

### Exemplary Handheld Embodiment of a Substance Delivery Apparatus

Referring to FIG. 9, a perspective view of a handheld substance delivery apparatus 900 is shown, in accordance with an exemplary embodiment of the invention. An ergonomic grip 902 is provided in some exemplary embodiments of the invention. Optionally, grip 902 includes a control mechanism 904 for activation (802) of handheld substance delivery apparatus 900. Optionally, control mechanism 904 is a trigger. Optionally, control mechanism 904 guarded by a trigger guard to prevent inadvertent activation of apparatus 900. Optionally, more than one control mechanism is provided to apparatus 900 for selectively activating injection of substances, for example if a user desires injection of one chemical being provided to apparatus 900, but not another; or, for example, if one chemical is to be provided to apparatus 900 in a different amount than another chemical. Optionally, a control mechanism is provided to apparatus 900 which allows a user to set a bolus size of reacted chemicals. Optionally, a control mechanism is a mode selector switch, provided to apparatus 900 to change the mode of operation of apparatus 900, for example from an automatically timed shot to a manually (as long as the main trigger is held) timed shot. As another example, the switch is provided for selecting at least one of a plurality of predefined injection operation profiles. Optionally, a plurality of injection profiles are defined for the chemical injection system, for example having a different profile for different sized receptacles with the user selecting a different operative profile depending on the receptacle. In some exemplary embodiments of the invention, a safety switch for preventing accidental activation of apparatus 900 is not considered a control mechanism.

In an exemplary embodiment of the invention, handheld substance delivery apparatus 900 includes a motor section 906 which includes motor 602. Optionally, position of motor section 906 is different than that shown in the Figures in order to balance the weight of handheld substance delivery apparatus 900 that is imparted by motor 602 to a user holding the handheld substance delivery apparatus 900. Optionally, an attachment 912 for electrical power is provided to apparatus 900. In an exemplary embodiment of the invention, apparatus 900 includes an injection section 908 for mounting cartridge 102 which is easily accessible for field maintenance or replacement of cartridge 102. In some exemplary embodiments of the invention, at least one chemical feed port 910 is provided to handheld substance delivery apparatus 900 for attaching hoses transporting chemicals for injection to handheld substance delivery apparatus 900. In some exemplary embodiments of the invention, a solvent feed port (not shown) is also provided to apparatus 900 for drawing solvent from solvent reservoir 112 for cleansing of apparatus 900. In an exemplary embodiment of the invention, cartridge 102 is partially visible protruding from apparatus 900, in particular purge rod tip 312. In an exemplary embodiment of the invention, an information display and/or a control panel is provided to apparatus 900 wherefrom a user can operate and gather information regarding the status of apparatus 900. Optionally, the information display and/or control panel is separate from apparatus 900. Optionally, the information pertains to the status of the chemical injection system in relation to an injection cycle. Optionally, the information pertains to the amount of supply materials (e.g. solvent and/or chemicals) remaining in supply reservoirs 110, 112.

FIG. 10 shows a cutaway view of apparatus 900 wherein a drive mechanism and cartridge 102 can be more readily seen, in accordance with an exemplary embodiment of the invention. Attached to motor 602 is a worm 604, such as described herein with respect to FIG. 6, which translates motive force from motor 602 to worm gear 606. Worm gear 606 motion clockwise or counter-clockwise serves to move the purge rod and the valve spool located in cartridge 102. At least one chemical inlet 204 can be seen in FIG. 10 which would be operatively connected to a chemical feed port 910, in some exemplary embodiments of the invention. In operation, substances are optionally ejected from apparatus 900 where purge rod tip 312 is located in FIG. 10.

In an exemplary embodiment of the invention, cartridge 102 is conveniently replaceable and/or serviceable by removing an apparatus 900 housing and detaching cartridge 102 from apparatus, such as described with respect to FIG. 2. Similarly, removal of apparatus 900 housing allows easy access to worm gear 606, allowing for replacement, maintenance or even manual operation of the apparatus 900. Optionally, removal of apparatus 900 housing is achieved by inserting a tool, such as a flat head screwdriver into a slot provided to the housing for such purpose. In an exemplary embodiment of the invention, at least one filter is provided to apparatus 900 for each chemical inlet port 204 for preventing particles, such as contaminants or crystallized chemical matter, from clogging chemical inlet port 204 or chemical pass-through ports 308. Optionally, the filters are held by injection section 908 such that the filters are relatively easy to inspect and/or replace when changing cartridge 102.

In some exemplary embodiments of the invention, cartridge 102 is useable with any of the drive mechanisms described herein. For example, cartridge 102 can be used in a substance delivery apparatus which employs a linear drive mechanism, detached from that apparatus, and placed in a different substance delivery apparatus which uses a rotational drive mechanism. It should be noted that, in an exemplary embodiment of the invention, replacement of cartridge 102 is all that is needed in order to restore a substance delivery apparatus to operational status after degradation of performance due to reacted chemical build-up. In some exemplary embodiments of the invention, the drive mechanism is independent of the cartridge used and therefore any of the drive mechanisms described or suggested herein are capable of use with more than one cartridge and optionally, more than one type of cartridge.

### Application to Exemplary Industries

While the present inventions have been described herein as having particular relevance to the packing material manufacturing industry, it should be understood that these apparatuses and methods find application in a wide variety of industries. The following description of application of the present inventions to other industries is by way of example only, and is not considered limited to these industries. It is conceived by the inventors that virtually any fluidic and/or foamy substance is capable of application with the inventions described or suggested herein.

For example, in the construction industry the chemical injection system related inventions described herein could optionally be used to apply foam insulation. Optionally, polyurethane and/or other similar chemicals are injected in construction applications. In some exemplary embodiments of the invention, chemical sealants and/or components of surface finishes are used in conjunction with the inventions described herein. Optionally, the apparatuses and methods described herein are used for the application of pipe insulation and/or HVAC foamed-in-place ductwork.

In some exemplary embodiments of the invention, the methods and apparatuses described herein are applied to the automotive industry. For example, the invention can optionally be used for the application of vibration control, noise proofing, fireproofing and/or cavity fill substances. In some exemplary embodiments of the invention, a body repair substance which is susceptible to cutting, sanding and painting is applied to an automobile exterior.

Another exemplary application of the described methods and apparatuses is the creation of injection molded components. In some exemplary embodiments of the invention, injection molding has application across multiple industries.

In some exemplary embodiments of the invention, landscaping features are manufactured using the presently described apparatuses and methods. Optionally, landscaping features include artificial boulders and/or rocks. Optionally, landscaping features include liners and/or shapes for pools, waterfalls and/or streams.

The presently described inventions can optionally be used in the marine and boating industry. In some exemplary embodiments of the invention, boat parts and accessories can be manufactured with the described inventions. Optionally, cavity fill material is applied to a marine structure, such as a boat, in accordance with an exemplary embodiment of the invention. Optionally, substances are applied to an engine well for vibration reduction, noise and/or fire proofing purposes. In some exemplary embodiments of the invention, flotation devices are manufactured using the herein described inventions.

The present invention has been described using non-limiting detailed descriptions of embodiments thereof that are provided by way of example and are not intended to necessarily limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. For example, a particular rotational drive mechanism is described herein, but it should be understood that any mechanism which effectuates rotational alignment of the valve spool, or a valve spool-like structure is contemplated in this application. Furthermore, the specification describes in detail a handheld embodiment of a substance delivery apparatus, but it should be understood that the handheld apparatus described herein is by way of example only and that any substance delivery apparatus which has a drive mechanism and is supplied with fluidic substances could be used with the cartridge described above. Therefore, the scope of the invention is limited only by the elements and limitations of the following claims, as issued.

1. A chemical injection system, comprising:
a drive mechanism;
a housing removably attached to said drive mechanism;
at least one chemical inlet located on said housing; and,
a valve spool located within said housing and provided with at least one chemical pass-through port, wherein said drive mechanism rotates said valve spool to align said chemical pass-through port with said chemical inlet.

2. A chemical injection system according to claim 1, further comprising a purge rod located within said valve spool and connected to said drive mechanism.

3. A chemical injection system according to claim 2, wherein said purge rod and said valve spool are located within said housing and comprise a cartridge.

4. A chemical injection system according to claim 2, wherein said drive mechanism provides over-travel movement to said purge rod.

5. A chemical injection system according to claim 2, wherein said system is provided with at least one sensor for determining the operational status of said purge rod.

6. A chemical injection system according to claim 5, wherein said at least one sensor is a bipolar magnetic sensor.

7. A chemical injection system according to claim 2, wherein said drive mechanism is comprised of at least a worm and a worm gear.

8. A chemical injection system according to claim 1, wherein said valve spool defines a mixing chamber located in a lumen of said valve spool.

9. A chemical injection system according to claim 1, wherein said valve spool further comprises an outlet.

10. A cartridge for a chemical injection system, comprising:
a housing provided with at least one chemical inlet port and at least one solvent inlet port for introducing solvent to said cartridge;
a valve spool, located concentrically within said housing, defining a mixing chamber and provided with at least one chemical pass-through port; and,
a purge rod, slidably located within said valve spool and provided with a connection for coupling said purge rod to a drive mechanism;
wherein said at least one chemical inlet port of said housing aligns with said at least one chemical pass-through port of said mixing chamber during chemical injection.

11. A cartridge according to claim 10, further comprising a spring for providing return movement to the valve spool after said drive mechanism has provided movement to the valve spool.

12. A cartridge according to claim 11, wherein said housing is provided with at least one slot for removably attaching said cartridge to said chemical injection system.

13. A cartridge according to claim 11, wherein said chemical injection system is handheld.

14. A cartridge according to claim 11, wherein said chemical injection system is non-handheld.

15. A method of using a chemical injection system, comprising:
moving a purge rod; and,
pumping solvent over an outlet of said chemical injection system by said moving of the purge rod.

16. A method according to claim 15, wherein said moving of the purge rod causes mechanical pumping of the solvent.

17. A method of breaking reacted chemical build-up in a chemical injection system, comprising:
commencing an over-travel movement of a purge rod towards an outlet of the chemical injection system thereby breaking any reacted chemical build-up; and,
moving the purge rod away from the outlet.

18. A method according to claim 17, wherein said movement occurs at the beginning of an injection cycle of the chemical injection system.

19. A method of urging a chemical inlet port towards a valve spool located in a cartridge, comprising:
providing at least one o-ring to an exterior surface of the chemical inlet port;
installing said cartridge in a substance delivery apparatus, wherein by said installing said cartridge said at least one o-ring becomes compressed; and,
wherein said compressed o-ring urges said chemical inlet port towards said valve spool.

20. A method according to claim 19, wherein said at least one o-ring is constructed of rubber.

21. A valve spool of a chemical injection system, comprising:
a perforated solvent groove, wherein said perforated solvent groove is provided with at least one hole for the transmission of solvent therethrough.

22. A valve spool according to claim 21, wherein a plurality of holes are equally spaced around a circumference of said solvent groove.

23. A valve spool according to claim 21, wherein said at least one hole is located at the thinnest portion of said groove in order to reduce the likelihood of reacted chemical buildup in said hole.

24. A valve spool according to claim 21, wherein said at least one hole is located upstream of a tip of said chemical injection system such that upon transmission of solvent through said at least one hole, said solvent flows over said tip.

25. A handheld chemical injection system, comprising:
a motor;
a drive mechanism operatively connected to said motor; and,
more than one control mechanism for controlling an aspect of operation of said handheld chemical injection system.

26. A handheld chemical injection system of claim 25, wherein said more than one control mechanism is a trigger for activating at least a portion of said chemical injection system.

27. A handheld chemical injection system of claim 25, wherein said more than one control mechanism is an operational mode selector switch.

28. A handheld chemical injection system of claim 25, wherein said more than one control mechanism is an injection operation profile selector switch.

29. A handheld chemical injection system of claim 25, wherein said more than one control mechanism is a bolus size selector switch.

30. A chemical injection system, comprising:
a handheld portion, wherein said handheld portion injects chemicals; and,
a display located on said handheld portion, wherein said display is operable to provide information regarding the chemical injection system.

31. A chemical injection system according to claim 30, wherein said information relates to an injection cycle.

32. A chemical injection system according to claim 30, wherein said information relates to the amount of at least one supply material remaining in at least one supply reservoir.

33. A chemical injection system according to claim 32, wherein said at least one supply material is a chemical.

34. A chemical injection system according to claim 32, wherein said at least one supply material is a solvent.

35. A method of using a chemical injection system, comprising:
moving a purge rod towards an “open” position;
rotationally aligning a valve spool upon attainment of said “open” position, wherein a chemical pass-through port on said valve spool is aligned with a chemical inlet port located on a housing of said valve spool;
moving said purge rod towards a “closed” position; and,
misaligning the valve spool upon said moving the purge rod towards said “closed” position.

36. A method according to claim 35, further comprising flowing solvent in said chemical injection system for cleansing.
